(19) United States
(12) Patent Application Publication
(10) Pub. No.: US 2025/0093885 A1
(43) Pub. Date: Mar. 20, 2025

(54) DOCKING SYSTEM FOR MOBILE ROBOT AND METHOD THEREOF

(71) Applicant: COGA ROBOTICS CO.,LTD., Seoul (KR)

(72) Inventors: Ilhong SUH, Seoul (KR); Yongnyeon KIM, Seoul (KR); Dongwook KO, Gyeonggi-do (KR); Taemin YEON, Gyeonggi-do (KR)

(21) Appl. No.: 18/964,717

(22) Filed: Dec. 2, 2024

Related U.S. Application Data
(63) Continuation of application No. PCT/KR2023/010758, filed on Jul. 25, 2023.

(30) Foreign Application Priority Data
Jun. 3, 2022 (KR) 10-2022-0068358

(51) Int. Cl. G05D 1/661; B60L 53/36; G05D 111/10

(52) U.S. Cl. CPC G05D 1/661; B60L 53/36; G05D 2111/17

(57) ABSTRACT

A method for docking a mobile robot with a charging station is disclosed. The method for docking a mobile robot with a charging station according to an embodiment may comprise the steps of: acquiring, by a LiDAR provided in the mobile robot, terrain information around the mobile robot; clustering consecutive points from distance and angle information to form a cluster; determining a location of the charging station from the cluster; and calculating a route to the charging station.

### CROSS-REFERENCE TO RELATED APPLICATION

This application is a US Bypass Continuation Application of International Application No. PCT/KR2023/010758, filed on Jul. 25, 2023, which claims priority to and the benefit of Korean Patent Application No. 10-2022-0068358, filed on Jun. 3, 2022, the disclosure of which is incorporated herein by reference in its entirety.

### BACKGROUND

### Technical Field

The present invention relates to a docking system, and more particularly, a method in which a mobile robot device docks a charging station.

### Background Art

Docking systems for automatic charging of automated guided vehicles (AGVs) or mobile robots utilizing a vision in related art perform docking by extracting QR markers or image features based on cameras.

However, this type of docking system causes motion noise in an image captured by the camera when there is a change in rotation or movement of the robot. Especially at a high speed, motion noise can be quite significant.

Therefore, most docking technologies using cameras use a method to reduce the motion noise of the camera by minimizing a rotational speed and a movement speed of the robot as much as possible, but this method takes a lot of time for docking, and if the robot's position error is large, a time required for docking is also very long. In addition, docking is performed using image information of the camera, and since an angle of view of a lens of the camera is narrow, docking attempts must be made as close a location as possible.

### SUMMARY

### Technical Problem

Therefore, an object to be achieved by the present invention is to quickly minimize a position error and a heading error of a robot by using only distance and angle information of a LiDAR.

The objects of the present invention are not limited to the above-mentioned objects, and other objects not mentioned can be clearly understood by those skilled in the art from the following description.

### Technical Solution

According to an embodiment, a method for docking a mobile robot with a charging station may include acquiring, by a LiDAR provided in the mobile robot, terrain information around the mobile robot; clustering consecutive points from distance and angle information to form a cluster; determining a location of the charging station from the cluster; and calculating a route to the charging station.

The calculating of the route to the charging station includes determining whether a left-right error between a center point of the charging system and a center point of the mobile robot exceeds a first threshold value, calculating a movement route based on an intermediate goal point closer to the mobile robot than the center point of the charging station in a front direction of the charging station when the left-right error exceeds the first threshold value, and moving the mobile robot based on the calculated movement route.

The calculating of the movement route may include determining a target intermediate goal point which comes in contact with a virtual circle surrounding the mobile robot among a plurality of candidate intermediate goal points which exist on a virtual line in a direction perpendicular to the charging station, and calculating a route moving to the target intermediate goal point.

The method for docking a mobile robot with a charging station according to an embodiment may further include: calculating the movement route in the direction of reducing a heading angle calculated based on an angle between the front direction of the charging station and a movement direction of the mobile robot when the left-right error does not exceed the first threshold value; and moving the mobile robot through the calculated movement route.

The determining of the location of the charging station may include comparing a length of the cluster and a length of the charging station, and when a difference value is greater than or equal to a predetermined size, excluding the corresponding candidate from a candidate cluster, and determining the location of the charging station among candidates whose difference values are less than the predetermined size.

According to an embodiment, a mobile robot may include: a LiDAR acquiring distance and angle information of surrounding objects of a mobile robot; a storage unit storing reference information of a charging station; and a control unit determining, as an intermediate goal point, a point where a virtual line in a direction perpendicular to the charging station and a virtual circle surrounding the mobile robot by using the distance and angle information, and calculating a route moving to the intermediate goal point and a route to the charging station.

Details of other embodiments will be included in the detailed description and the drawings.

### Advantageous Effects

According to embodiments of the present invention, a docking system performs docking quickly and accurately by using only distance and angle information of surrounding objects acquired by a LiDAR without using any other separate sensors to enhance a docking performance.

The effects according to the embodiments of the present invention are not limited by the contents exemplified above, and other various effects are included in this specification.

### BRIEF DESCRIPTION OF THE DRAWINGS

FIG. 1 is a conceptual diagram of a docking system according to an embodiment of the present invention.

FIG. 2 is a flowchart for describing a docking method according to an embodiment of the present invention.

FIG. 3 illustrates information acquired by a LiDAR of a mobile robot according to an embodiment of the present invention.

FIG. 4 illustrates that the information acquired by the LiDAR is clustered according to an embodiment of the present invention.

FIG. 5 illustrates a result of extracting a charging station among clusters according to an embodiment of the present invention.

FIG. 6 illustrates reference information of the charging station stored in a storage unit according to an embodiment of the present invention.

FIG. 7 illustrates entire information around the mobile robot acquired by the LiDAR according to an embodiment of the present invention.

FIG. 8 is a flowchart specifically illustrating a method for calculating a movement route to a charging station according to an embodiment of the present invention.

FIG. 9 is a diagram for exemplarily describing a method in which a control unit moves a mobile robot through a first mode according to an embodiment.

FIG. 10 is a diagram for exemplarily describing a method in which the control unit moves the mobile robot through a second mode according to an embodiment.

FIG. 11 is a diagram for exemplarily describing a process for the mobile robot to correct a route according to an embodiment.

FIGS. 12A to 12D are diagrams exemplarily illustrating a result of simulating a charging station docking method according to an embodiment.

### DETAILED DESCRIPTION

Advantages and features of the present invention, and methods for accomplishing the same will be more clearly understood from embodiments described in detail below. However, the present invention is not limited to the following embodiments but may be implemented in various different forms. The embodiments are provided only to make description of the present invention complete and to fully provide the scope of the present invention to a person having ordinary skill in the art to which the present invention pertains, and the present invention will be just defined by the appended claims.

It is also to be understood that the terms used herein is for the purpose of describing embodiments only and is not intended to limit the present invention. In this specification, ‘and/or’ includes each and every combination of one or more of the mentioned items. Further, singular forms include even plural forms unless the context clearly indicates otherwise. It is to be understood that the terms “comprise” and/or “comprising” used in the specification does not exclude the presence or addition of one or more other components other than stated components. A numerical range indicated by ‘-’ or ‘in between’ indicates a numerical range that includes the values stated before and after it as the lower and upper limits, respectively, unless otherwise stated. ‘About’ or ‘approximately’ means a value or numerical range within 20% of the value or numerical range stated thereafter.

In describing the components of the embodiments of the present invention, terms including first, second, A, B, (a), (b), and the like may be used. These terms are just intended to distinguish the components from other components, and the terms do not limit the nature, sequence, or order of the components.

Unless otherwise defined, all terms (including technical and scientific terms) used in this specification may be used as the meaning which may be commonly understood by the person with ordinary skill in the art, to which the present invention pertains. Terms defined in commonly used dictionaries should not be interpreted in an idealized or excessive sense unless expressly and specifically defined.

Further, in describing the embodiments of the present invention, a detailed explanation of known related configurations and functions may be omitted to avoid interruption of understanding of the embodiments of the present invention.

A docking system of the present invention enables a mobile robot to dock quickly and accurately with a charging station.

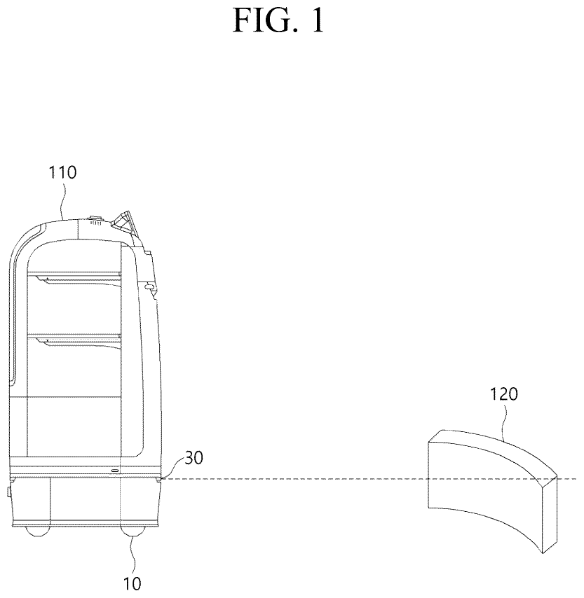

FIG. 1 is a conceptual diagram of a docking system according to an embodiment of the present invention.

The docking system according to an embodiment may include a mobile robot 110 and a charging station 120.

The mobile robot 110 according to an embodiment may include wheels 10, a laser sensor (Lidar) 30 that two-dimensionally acquires distance and angle information of objects around the mobile robot 110, and a control unit (not illustrated) that calculates a route to the charging station 120 using the distance and angle information. In addition, the mobile robot 110 may be configured to further include a storage unit (not illustrated) that stores reference information of the charging station 120. The mobile robot 110 may dock with the charging station 120 using the wheels 10 under the control of the control unit (not illustrated), and a series of communications may be performed through a provided communication interface.

According to various embodiments, the storage unit may store various data used by at least one component (e.g., the control unit or the communication interface) of the mobile robot 110. The data may include, for example, software (e.g., a program), and input data or output data for a command related to the software. The storage unit may include a volatile memory or a non-volatile memory.

The communication interface may support establishment of a direct (e.g., wired) communication channel or a wireless communication channel between the mobile robot 110 and an external electronic device (e.g., a control hub, an external sensing device), and communication execution through the established communication channel. The communication interface may include one or more communication processors which are operated independently from the control unit (e.g., the application processor), and support the direct (e.g., wired) communication or the wireless communication. According to an embodiment, the communication interface may include a wireless communication module (e.g., a cellular communication module, a short-range wireless communication module, or a global navigation satellite system (GNSS) communication module) or a wired communication module (e.g., a local area network (LAN) communication module, or a power line communication module). A corresponding communication module among the communication modules may communicate with the external electronic device (e.g., a control hub, an external sensing device, etc.) through a first network (e.g., a short-range communication network such as Bluetooth, wireless fidelity (Wi-Fi) direct or infrared data association (IrDA)) or a second network (e.g., a long-range communication network such as a legacy cellular network, a 5G network, a next-generation communication network, the Internet, or a computer network (e.g., LAN or WLAN)). The types of communication modules may be integrated into one component (e.g., single chip), or may be implemented as a plurality of separate components (e.g., plural chips).

The laser sensor (LiDAR) 30 may measure a distance to an object, etc. by emitting a laser pulse and receiving the light that is reflected and returned from a surrounding target object. Specifically, the LiDAR may precisely draw a surrounding state by emitting a large number of lights around the LiDAR. Depending on a level of information that may be acquired, the LiDAR may be divided into a 3D LiDAR that may obtain 3D information and a 2D LiDAR that may obtain 2D information. In an embodiment, the docking system may perform docking quickly and accurately using only distance information acquired using the 2D LiDAR.

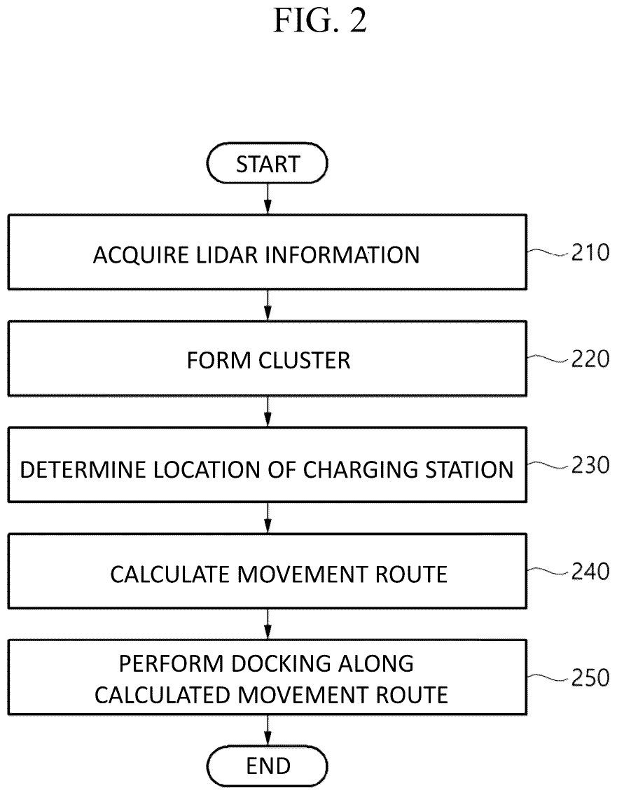

According to an embodiment, the control unit may cluster consecutive points based on the distance and angle information acquired by the LiDAR, and determine a location of the charging station 120 based on at least one of the clustered clusters. More specifically, a length of the cluster and a length of the charging station 120 are compared, and when a difference value is greater than a predetermined size, the candidate may be excluded from the candidate group, and the location of the charging station 120 may be determined based on a candidate whose difference value is less than the predetermined size. The method for determining the location of the charging station 120 is described in detail in FIG. 2.

The control unit according to an embodiment may be provided inside the mobile robot 110 as an example, but is not limited thereto and may be provided outside the mobile robot 110. In addition, in some cases, it is possible to implement a method of providing calculated information to the mobile robot 110 by using wireless communication while being separated from the mobile robot 110. For example, the mobile robot 110 may have a communication unit, and the communication unit may be connected to a control unit that exists separately from the mobile robot 110 through wireless communication, and the mobile robot 110 may be implemented to move using information delivered from the control unit. For example, the control unit may include a main processor (e.g., a central processing unit or an application processor) and an auxiliary processor (e.g., a graphic processing unit, a neural processing unit (NPU), an image signal processor, a sensor hub processor, or a communication processor) which is operable independently from or together with the main processor. For example, when the mobile robot 110 includes the main processor and the auxiliary processor, the auxiliary processor may be configured to use lower power than the main processor or to be specialized for a given function. The auxiliary processor may be implemented separately from the main processor, or as part thereof.

Hereinafter, a case where the control unit is embedded in the mobile robot 110 is described, but is not limited thereto.

The charging station 120 may charge the battery embedded in the mobile robot 110

when the mobile robot 110 approaches within a predetermined distance. The charging station 120 may charge the battery by coming into contact with one side of the mobile robot 110, and in some cases, it is also possible to charge the battery using a wireless power transmission method. The wireless power transmission method may use an inductive charging method and a resonant inductive coupling method, but is not limited thereto and may be modified from the perspective of those skilled in the art. A detailed description of wireless power transmission is omitted.

FIG. 2 is a flowchart for describing a docking method according to an embodiment of the present invention.

A docking method performed by the control unit of the mobile robot according to an embodiment may include a step of acquiring LiDAR information (210), a step of forming a cluster based on the LiDAR information (220), a step of determining a location of a charging station based on a cluster (230), a step of calculating a movement route based on the location of the charging station (240), and a step of performing docking with the charging station according to the calculated movement route (250). Hereinafter, each step will be described in detail.

The step of acquiring the LiDAR information (210) is a step of acquiring location information of surrounding objects or walls by measuring a time for which the LiDAR of the mobile robot emits light to the surroundings and the light is returned. Specifically, light may be emitted around the mobile robot equipped with the LiDAR to obtain information about the distance and direction based on the LiDAR.

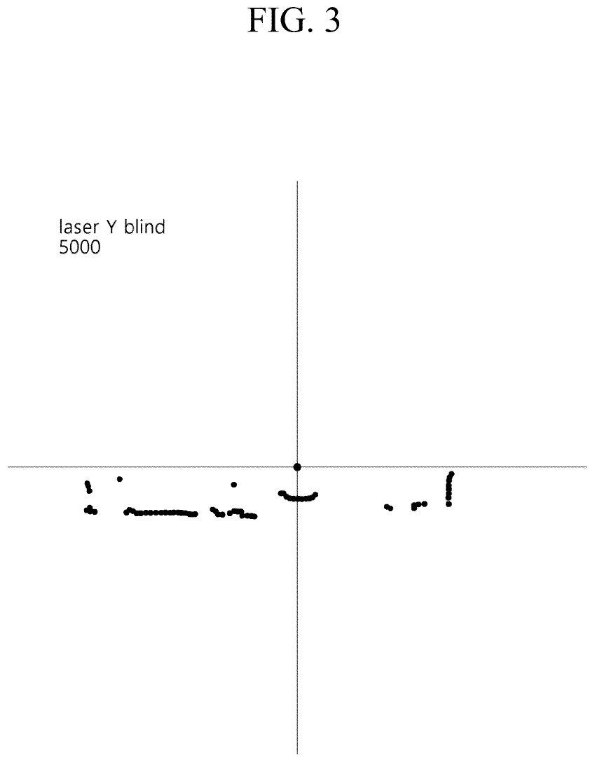

FIG. 3 illustrates information acquired by a LiDAR of a mobile robot according to an embodiment of the present invention.

Referring to FIG. 3, the information acquired by the LiDAR is visualized and depicted. A center of the LiDAR is an origin (a point where a vertical axis and a horizontal axis intersect with each other), and black dots around the LiDAR represent locations on a coordinate system by utilizing the light reflected and returned at each location.

The step of forming the cluster (220) is a step of forming the cluster by clustering respective points by using the information acquired by the LiDAR.

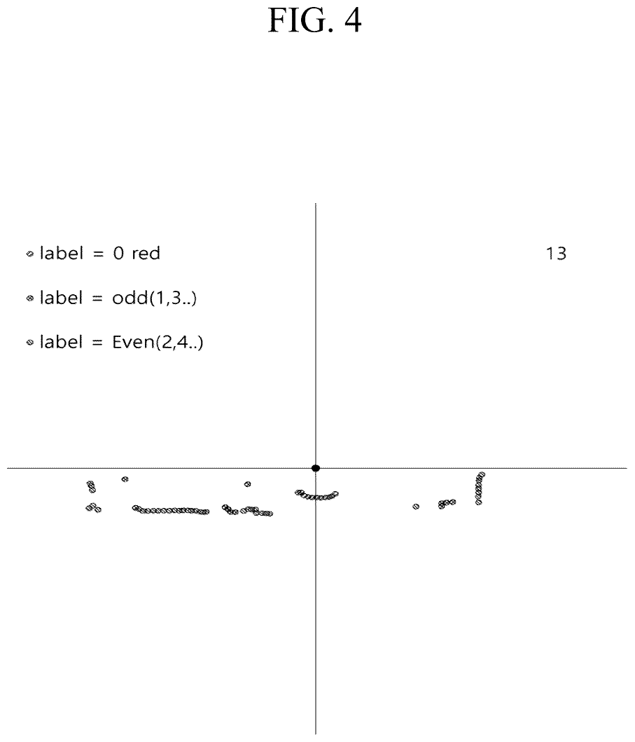

FIG. 4 illustrates that the information acquired by the LiDAR is clustered according to an embodiment of the present invention.

Referring to FIG. 4, it can be seen that the information acquired by the LiDAR is clustered according to an embodiment of the present invention.

Specifically, points located within a predetermined distance from each point may be clustered into one cluster. Therefore, it may be understood that continuous points are clustered and that each cluster unit is formed as one object or wall.

In addition, the docking system according to an embodiment may perform labeling for each cluster. When the number of points constituting each cluster is odd, each cluster may be labeled with odd, and when the corresponding number is even, it is also possible that each cluster is labeled differently. It will be appreciated by those skilled in the art that the method of performing labeling is not limited to the presented example.

Next, the step of determining the location of the charging station 230 is a step of determining the charging station by comparing information of each cluster and prestored reference information of the charging station.

The step of determining the location of the charging station (230) according to an embodiment may determine the location of the charging station by comparing the length information (or size information) of each clustered cluster with stored length (or size) information of the charging station. Specifically, if a difference value between the length of each cluster and the length of the charging station is greater than a predetermined value, the charging station may be excluded from the charging station candidates. And, the charging station may be determined by using clusters whose difference value is less than the predetermined value as the candidates. That is, clusters that are too short or too long compared to a predetermined length for the charging station may be excluded from the candidates.

Further, laser pattern matching is performed with an actual charging station to determine a candidate with a most similar shape. An iterative closest point (ICP) algorithm may be used in this process.

The ICP algorithm means an algorithm that combines and registers two data when there are two point clusters scanned at different points on an object. The ICP algorithm is an algorithm that is repeatedly performed to match the closest points. A detailed description of the ICP algorithm is omitted.

That is, the stored reference information of the charging station has length and shape information of the charging station as one cluster. By repeatedly comparing the reference information with data of clusters measured by the LiDAR, a cluster closest to the actual charging station may be found, and a location of the closest cluster may be determined as a location of the actual charging station. For example, the control unit may determine a candidate that is most similar to the reference information among the candidates through a process of comparing a plurality of points included in the candidate cluster and a plurality of points included in the reference information 1:1, and determine the candidate as the cluster with the highest similarity.

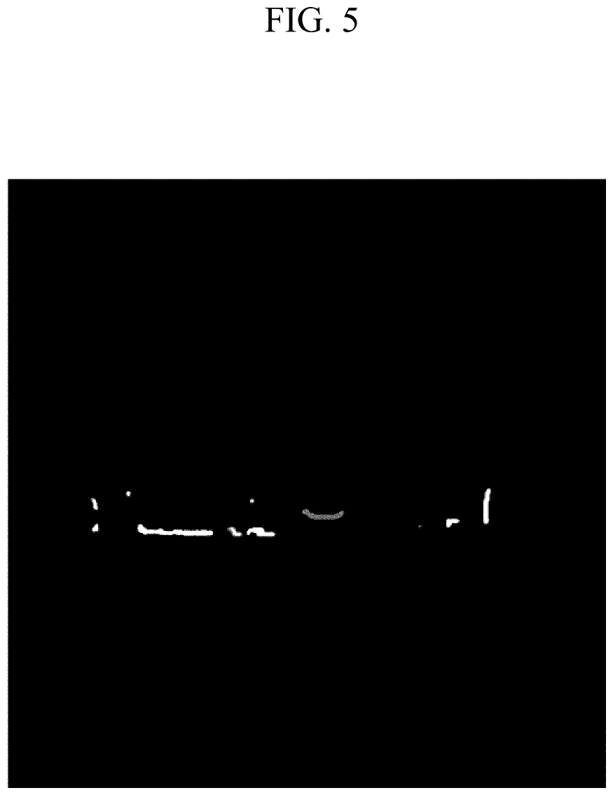

FIG. 5 illustrates a result of extracting a charging station among clusters according to an embodiment of the present invention.

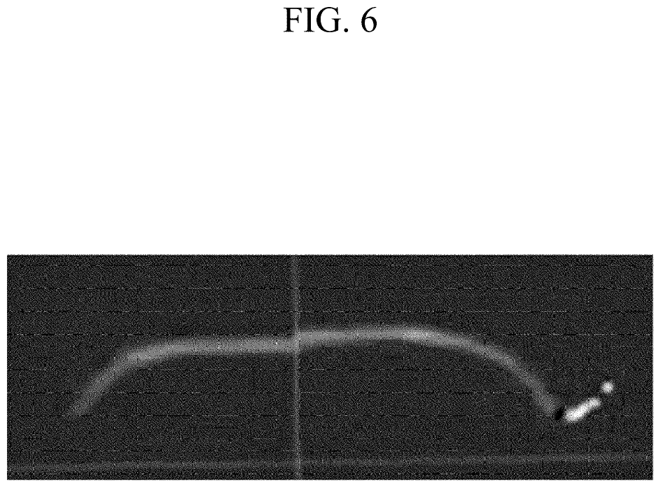

Further, FIG. 6 illustrates the stored reference information of the charging station.

Therefore, the docking system according to an embodiment may determine the most approximate charging station and a location thereof by comparing the stored reference information and each clustered cluster acquired by the LiDAR.

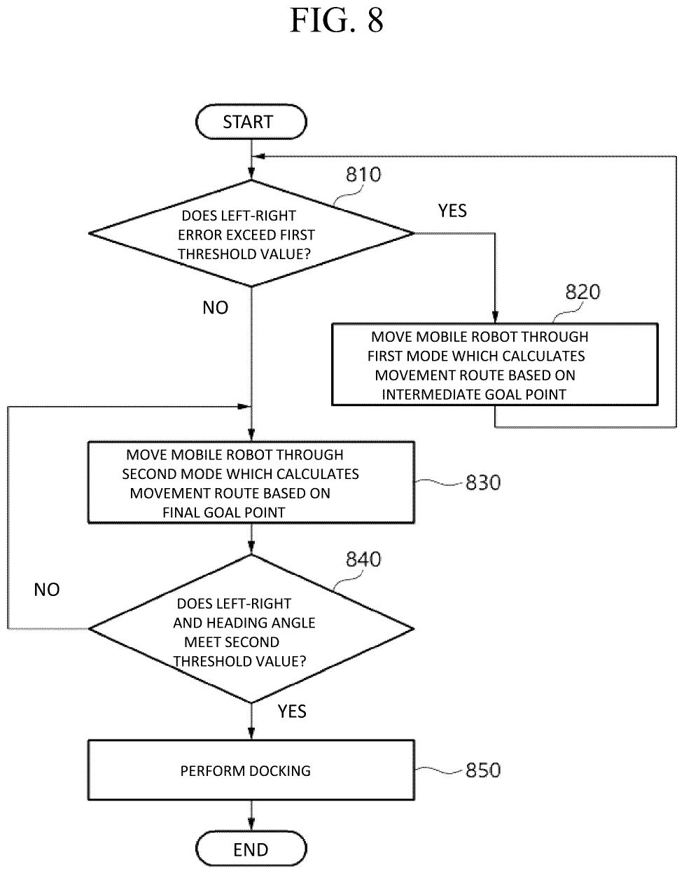

The step of calculating the movement route 240 is a step of calculating a route along which the mobile robot moves to the location of the determined charging station. A specific method for calculating the movement route is described in detail in FIG. 8, so it is omitted here.

The step of performing docking according to the calculated movement route (250) may allow the mobile robot to dock with the charging station according to the movement route calculated in the previous step.

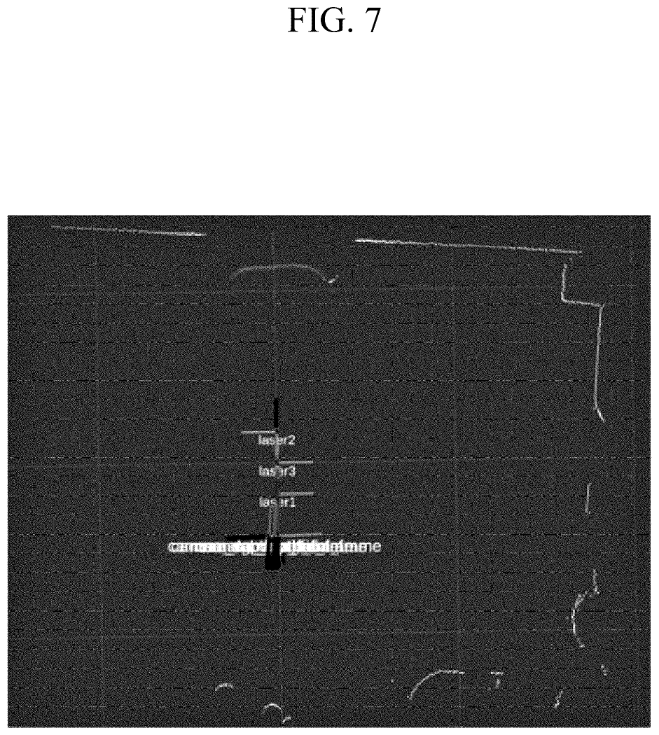

FIG. 7 illustrates entire information around the mobile robot acquired by the LiDAR according to an embodiment of the present invention.

2D information about objects and walls formed around the mobile robot may be acquired through the previously described LiDAR. Points extracted from the entire coordinate area are clustered to form the cluster, and the cluster closest to the charging station is determined as the charging station, thereby determining the location of the charging station. Afterwards, the route to the charging station is calculated to control the mobile robot to move along the route. The mobile robot may obtain the LiDAR information described above through one sensor (e.g., laser 2) corresponding to the 2D LiDAR among a plurality of sensors indicated as laser 1, laser 2, and laser 3.

FIG. 8 is a flowchart specifically illustrating a method for calculating a movement route to a charging station according to an embodiment of the present invention.

When attempting to dock along a shortest straight route from a current location of the mobile robot to a center point (final goal point) of the charging station, if an angle at which the mobile robot attempts to dock is greater than a predetermined angle from a normal line of the charging station or if an error between an actual center point and the center point calculated by the control unit is large, docking may not be successful.

Therefore, the method for calculating the movement route to the charging station according to an embodiment may include a step (810) of determining whether a left-right error between the charging station and the mobile robot exceeds a first threshold value, a step (820) of moving the mobile robot through a first mode that calculates a movement route based on an intermediate goal point if the left-right error exceeds the first threshold value, a step (830) of moving the mobile robot through a second mode that calculates a movement route based on a final goal point if the left-right error does not exceed the first threshold value, a step (840) of determining whether the left-right error and a heading angle meet a second threshold value, and a step (850) of performing docking if the left-right error and the heading angle meet the second threshold value. Each step may be performed by the control unit equipped on the mobile robot.

According to an embodiment, the control unit of the mobile robot may, in the process of determining the charging station based on the clustering described above, calculate a midpoint of both end points of the cluster determined as the charging station and determine the calculated midpoint as the center point of the charging station. The control unit may determine the determined center point as a final goal point.

According to another embodiment, in order to correct a measurement error of the LiDAR, it is also possible that a point spaced apart at a predetermined distance from the center point while considering a rotation direction of the LiDAR is determined as the center point of the charging station, and the determined center point is determined as the final goal point. For example, when the LiDAR collects surrounding distance and angle information while the mobile robot rotates clockwise, an error due to the rotation of the mobile robot may occur, and a point slightly closer to a right end point than the midpoint of both end points may also be determined as the center point of the charging station.

According to an embodiment, the control unit may determine whether the left-right error between the previously determined final goal point and the center point of the mobile robot exceeds a first threshold value (810). The control unit may perform a preliminary operation to smoothly perform docking through a movement route according to the first mode for reducing the left-right error based on an intermediate goal point when the left-right error exceeds the first threshold value, and perform docking by utilizing a movement route that reflects error correction based on the final goal point when the left-right error does not exceed the first threshold value. For example, it will be understood by those skilled in the art that the first threshold value may be set to 100 mm, but the first threshold value may be set differently depending on the embodiment.

When the control unit determines that the left-right error exceeds the first threshold value in step 810, the control unit may move the mobile robot through the first mode that calculates the movement route based on the intermediate goal point through step 820.

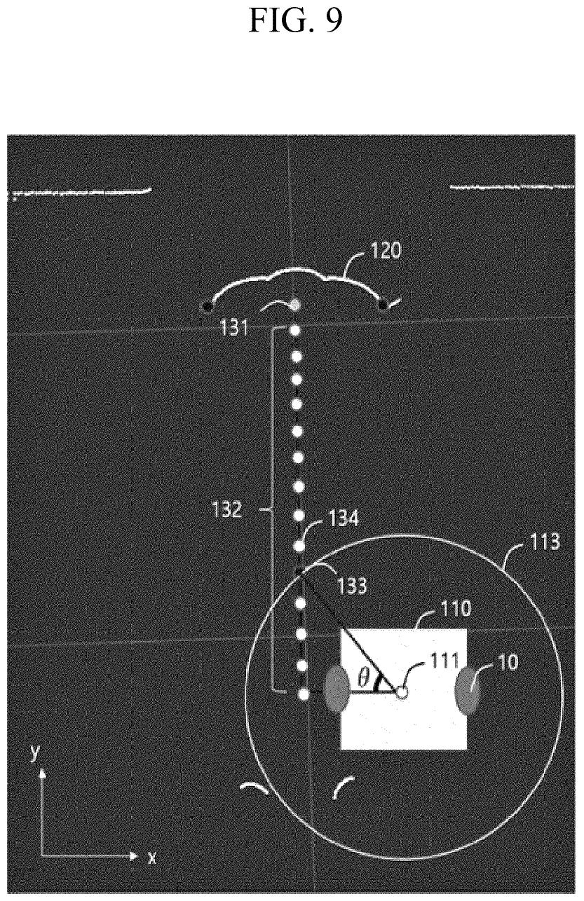

FIG. 9 is a diagram for exemplarily describing a method in which a control unit moves a mobile robot through a first mode according to an embodiment of the present invention.

The mobile robot 110 may dock with the charging station 120 by moving along a movement route calculated based on a final goal point 131 and a target intermediate goal point 133.

The mobile robot 110 may perform an operation based on the first mode that calculates the movement route based on a candidate intermediate goal point 132 when the left-right error between the final goal point 131 determined according to the method described above and a center 111 (e.g., a center of the wheel 10) of the mobile robot exceeds the first threshold value. The left-right error may refer to a location difference on an x axis illustrated.

The candidate intermediate goal point 132 may be set as a plurality of points in a front direction of the charging station 120 (for example, in a direction perpendicular to a straight line connecting both end points of the charging station 120), and for example, the candidate intermediate goal point 132 may be set as a plurality of points at equal intervals in the direction described above.

The control unit of the mobile robot 110 may select a first target intermediate goal point 133 that is in contact with a virtual circle 113 surrounding the mobile robot 110 among a plurality of candidate intermediate goal points 132, and calculate the movement route based on the first target intermediate goal point 133.

A radius of the virtual circle 113 may be changed according to the embodiment, and may be set by considering the size of the mobile robot 110, the size of the charging station 120, the distance between the mobile robot and the charging station, etc. from the standpoint of those skilled in the art.

The control unit may calculate a movement route to the first target intermediate goal point 133 in the first mode and move the mobile robot 110 based on the calculated route.

The movement route up to the first target intermediate point 133 may be implemented by various methods. For example, the control unit may determine the movement route so that the mobile robot 110 may rotate and move at θ (90-θ according to an embodiment) counterclockwise, and the center 111 of the robot may reach the first target intermediate goal point 133, and controls a speed of the wheel 10 and a rotation speed of the mobile robot 110 so that the robot may move through the determined movement route. As another example, but not limited thereto, the mobile robot 110 may move in a straight route to the first target intermediate goal point 133.

According to an embodiment, when a situation occurs in which the left-right error does not exceed the first threshold value while the mobile robot 110 moves to the first target intermediate goal point 133, the control unit may move the mobile robot through the second mode that calculates the movement route based on the final goal point 131 (830).

According to another embodiment, when the mobile robot 110 moves along the movement route determined based on the first target intermediate goal point 133, if the virtual circle 113 comes into contact with one of a plurality of candidate intermediate goal points 132 (for example, if the second target intermediate goal point 134 and the virtual circle 113 come into contact), the control unit determines the second target intermediate goal point 134 as a candidate intermediate goal point, and resets the movement route based on the determined second target intermediate goal point 134 to move the mobile robot 110. The method for determining the movement route based on the second target intermediate goal point 134 may be the same as the method for determining the route based on the first target intermediate goal point 133.

According to another embodiment, the control unit may perform the process according to the first mode by resetting the movement route and moving the mobile robot 110 by repeating the operation described above whenever the virtual circle 113 comes into contact with different candidate intermediate goal points 132 during the movement of the mobile robot 110, and the first mode may be repeated until the situation occurs in which the left-right error does not exceed the first threshold value.

When the control unit determines that the left-right error does not exceed the first threshold value in step 810, the control unit may move the mobile robot through the second mode that calculates the movement route based on the intermediate goal point 131 through step 830.

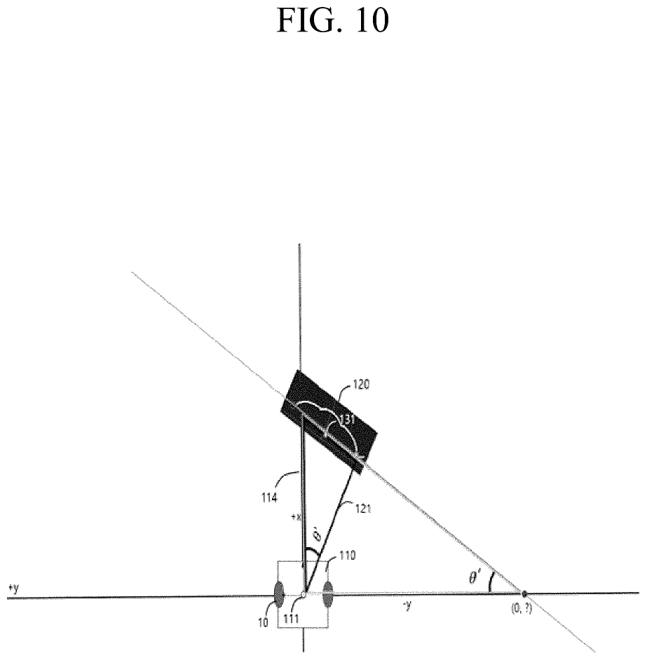

FIG. 10 is a diagram for exemplarily describing a method in which the control unit moves the mobile robot through a second mode according to an embodiment.

Referring to FIG. 10, the control unit of the mobile robot 110 may calculate the movement route of the mobile robot 110 based on a location relationship between the charging station 120 and the mobile robot 110 in the second mode.

More specifically, the control unit may set the center 111 of the robot as the origin, the straight line connecting the two wheels 10 as a y axis, and a rear direction of the mobile robot 110 as a positive direction of the x axis. The control unit may calculate an equation of a straight line connecting both ends of the charging station 120, calculate a y-intercept value where the straight line intersects the y axis, and calculate a heading angle θ′ between a heading direction 114 of the mobile robot 110 and the front direction 121 of the charging station 120 through the calculation result.

The control unit may calculate the movement route so that the mobile robot 110 approaches the charging station 120 by rotating so that the heading angle θ′ becomes 0. For example, the control unit may calculate the movement route so that the heading angle θ′ becomes 0 during the process of the robot center 111 moving toward the final goal point 131 which is the center of the charging station 120, and move the mobile robot 110 based on the calculated movement route. More specifically, the movement route may be set so that the center 111 of the robot reaches the final goal point 131, and the heading angle θ′ becomes 0, and the speed of the wheel 10 and the rotation speed of the mobile robot 110 may be determined so that the mobile robot 110 moves along the movement route.

According to an embodiment, the control unit may determine, in step 840, whether the left-right error and the heading angle meet the second threshold value. The second threshold value may include a threshold value for the left-right error and a threshold value for the heading angle.

For example, when the control unit determines that the left-right error is less than 40 mm and the heading angle is less than 7 degrees during the process of moving the mobile robot 110 in the method described above, the control unit may cause the mobile robot 110 to dock with the charging station 120 (850). The control unit may control the mobile robot 110 in the direction of reducing the left-right error and heading angle until the point at which LiDAR data is no longer acquired in the previous step 830, and when the left-right error and heading angle meet the second threshold value according to the control result, the mobile robot 110 may be controlled to dock with the charging station 120 through step 850. When performing docking in step 850, the control unit may control the mobile robot 110 to dock while reducing the rotation speed of the mobile robot 110 as much as possible and maintaining the movement speed constant.

According to an embodiment, the control unit may further perform a process of modifying the movement route of the mobile robot 110 when a predetermined condition is met during the process of performing docking in step 850. According to an embodiment, the route of the mobile robot may be corrected when the left-right error is greater than a predetermined distance or when the angle formed by the direction in which the mobile robot is moving and the normal line is greater than a predetermined angle. This reduces the error through the previous movement route, and even if the mobile robot 110 moves to the charging station, if the angle at which the mobile robot enters the charging station or a distance error of the mobile robot is large, docking may not be performed properly, so the process of correcting the route may be further performed.

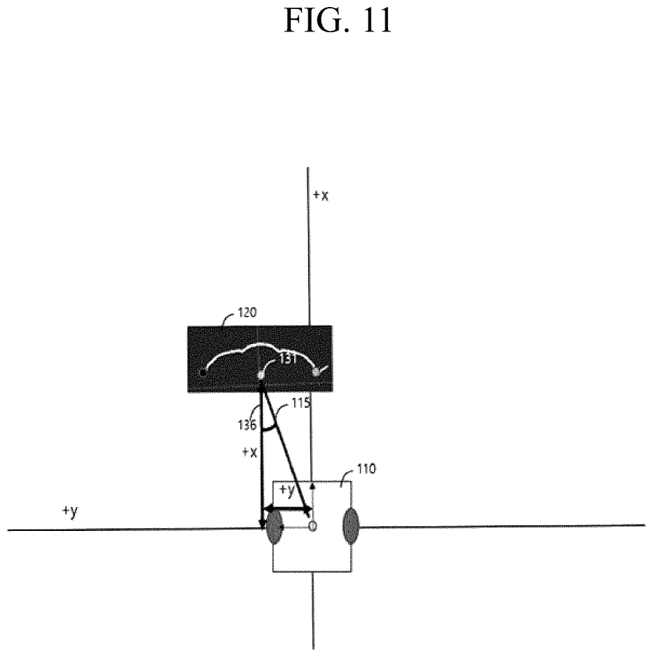

FIG. 11 is a diagram for exemplarily describing a process for the mobile robot to correct a route according to an embodiment.

Referring to FIG. 11, when the angle between the direction 115 in which the mobile robot 110 is moving and the normal line 136 is greater than the predetermined angle, the mobile robot 110 may be aligned by rotating in a direction parallel to the normal line 136, move in a direction to be away from the charging station 120, and then re-enter.

As described above, the docking system of the present invention may expect rapid and accurate docking performance by using only information acquired by the 2D LiDAR without using brightness information of the LiDAR, sound wave transmitter/receiver, etc.

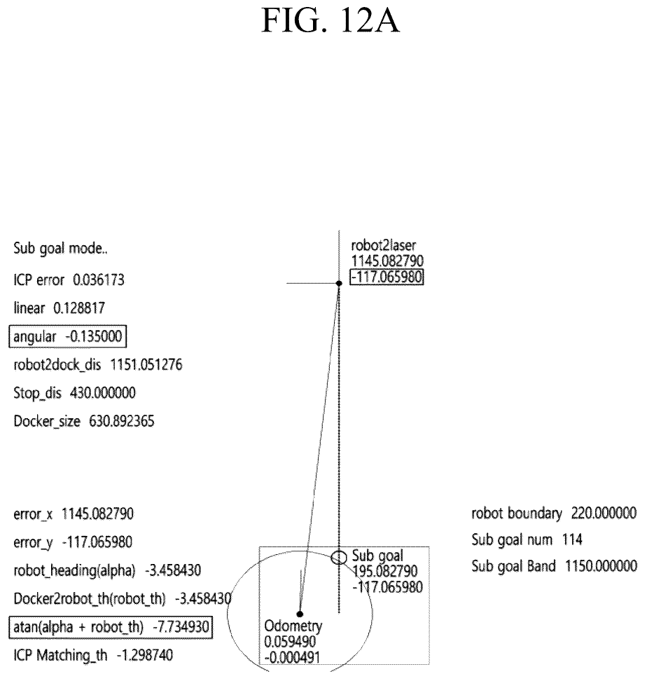

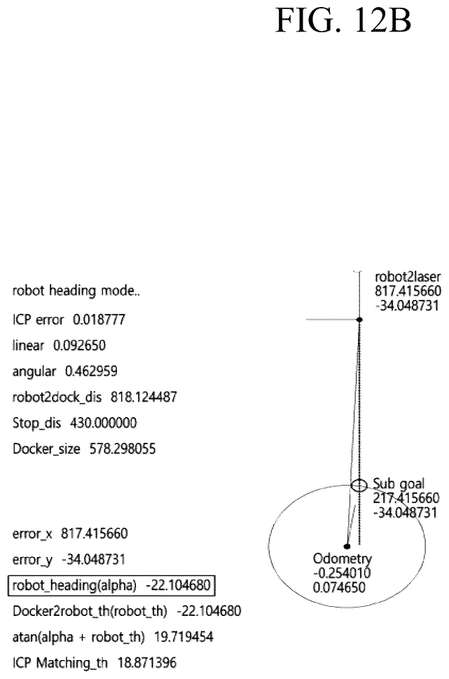

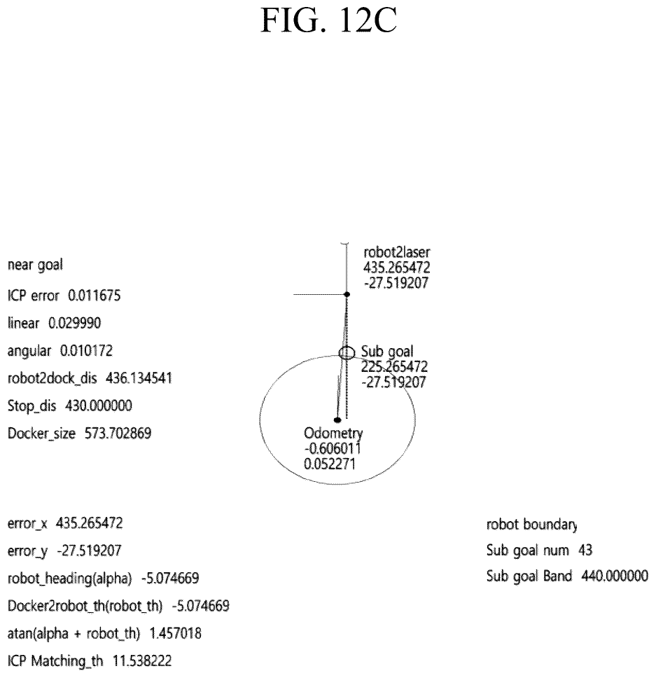

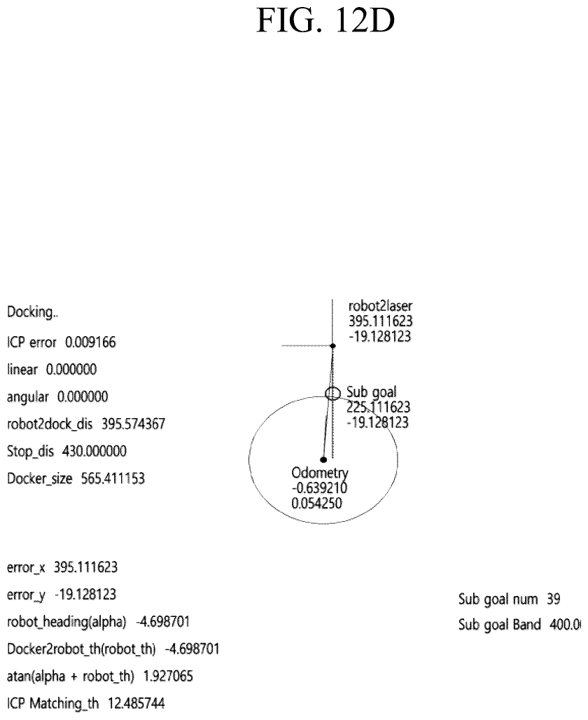

FIGS. 12A to 12D are diagrams exemplarily illustrating a result of simulating a charging station docking method according to an embodiment.

Referring to FIG. 12A, if the left-right error between the center of the robot indicated by a dot corresponding to odometry and a final goal point indicated by a dot corresponding to robot2laser is greater than or equal to the first threshold value (e.g., 100 mm), the movement route is derived based on an intermediate goal point corresponding to sub goal based on a first mode (expressed as sub goal mode), and the robot moves based on the derived movement route, so the left-right error may be greatly reduced. For example, since an angle between the intermediate goal point and the center of the mobile robot is −7.73490 degrees, the mobile robot may move to the intermediate goal point (denoted as sub goal) by rotating at −7.73490 degrees/s.

Referring to FIG. 12B, if the left-right error is reduced below the first threshold value through the preceding operation, the mobile robot may calculate the movement route so that the heading angle calculated based on the final goal point becomes 0 based on the second mode (expressed as heading mode). For example, if a current heading angle of the mobile robot is −22.104680 degrees, the robot may rotate at 22.104680 degrees/s and move to the final goal point.

Referring to FIG. 12C, when the left-right error and heading angle of the mobile robot converge below a predetermined level, the error (heading angle and left-right error) may be reduced until the LiDAR data is no longer acquired, and docking may be performed when a docking allowance condition is met. Docking may be performed if the docking allowance condition (e.g., the heading angle is within 7 degrees and the left-right error is within 40 mm) are met through the preceding error reduction process.

Referring to FIG. 12D, when the docking allowance condition is met, the mobile robot may perform docking by reducing the rotation speed of the robot as much as possible and maintaining the movement speed constant.

Although the embodiments of the present invention have been mainly described above, these are merely examples and do not limit the present invention, and those skilled in the art to which the present invention pertains will know that various modifications and applications not illustrated above can be made within the scope without departing from the essential characteristics of the embodiment of the present invention. For example, each component specifically shown in the embodiment of the present invention may be implemented by being modified. In addition, it will be interpreted that differences related to the modifications and applications are included in the scope of the present invention defined in the appended claims.

What is claimed is:

1. A method for docking a mobile robot with a docking system, the method comprising:
acquiring, by a LiDAR provided in the mobile robot, terrain information around the mobile robot;
clustering consecutive points from distance and angle information to form a cluster;
determining a location of the charging station from the cluster; and
calculating a route to the charging station.

2. The method for docking a mobile robot with a docking system of claim 1, wherein the calculating of the route to the charging station includes:
determining whether a left-right error between a center point of the charging system and a center point of the mobile robot exceeds a first threshold value;
calculating a movement route based on an intermediate goal point closer to the mobile robot than the center point of the charging station in a front direction of the charging station when the left-right error exceeds the first threshold value; and
moving the mobile robot based on the calculated movement route.

3. The method for docking a mobile robot with a docking system of claim 2, wherein the calculating of the movement route includes:
determining a target intermediate goal point which comes in contact with a virtual circle surrounding the mobile robot among a plurality of candidate intermediate goal points which exist on a virtual line in a direction perpendicular to the charging station; and
calculating a route moving to the target intermediate goal point.

4. The method for docking a mobile robot with a docking system of claim 2, further comprising:
calculating the movement route in the direction of reducing a heading angle calculated based on an angle between the front direction of the charging station and a movement direction of the mobile robot when the left-right error does not exceed the first threshold value; and
moving the mobile robot through the calculated movement route.

5. The method for docking a mobile robot with a docking system of claim 1, wherein the determining of the location of the charging station includes:
comparing a length of the cluster and a length of the charging station, and when a difference value is greater than or equal to a predetermined size, excluding the corresponding candidate from a candidate cluster; and
determining the location of the charging station among candidates whose difference values are less than the predetermined size.

6. A mobile robot comprising:
a LiDAR acquiring distance and angle information of surrounding objects of a mobile robot;
a storage unit storing reference information of a charging station; and
a control unit determining, as an intermediate goal point, a point where a virtual line in a direction perpendicular to the charging station and a virtual circle surrounding the mobile robot by using the distance and angle information, and calculating a route moving to the intermediate goal point and a route to the charging station.
